(19) United States
(12) Patent Application Publication
(10) Pub. No.: US 2019/0179754 A1
(43) Pub. Date: Jun. 13, 2019

(54) MEMORY BARRIERS IN A COHERENCE DIRECTORY

(71) Applicant: International Business Machines Corporation, Armonk, NY (US)

(72) Inventor: Burkhard Steinmacher-Burow, Esslingen am Neckar (DE)

(21) Appl. No.: 15/840,055

(22) Filed: Dec. 13, 2017

(51) Int. Cl. G06F 12/0817; G06F 12/1009

(52) U.S. Cl. CPC G06F 12/0828; G06F 2212/65; G06F 2212/621; G06F 12/1009

(57) ABSTRACT

A method for issuing memory barrier instructions includes creating a transient table including records corresponding to one or more participant caches in a system, receiving a command for an address corresponding to one of the participant caches, determining whether one or more outstanding requests exist that must be executed before a barrier command is executed with respect to the participant cache, responsive to determining an outstanding request exists that must be executed before a barrier command is executed, incrementing a counter to reflect an instance in which an address with one or more outstanding requests was accessed, detecting the execution of the one or more outstanding requests, responsive to detecting the execution of the one or more outstanding requests, decrementing the counter, determining whether the counter has a value of zero, and responsive to determining the counter has a value of zero, issuing a memory barrier operation.

### BACKGROUND OF THE INVENTION

The present invention relates generally to the field of cache coherence, and more specifically to improving efficiency in memory barriers in a coherence directory.

Cache coherence refers to the uniformity of shared resource data that ends up stored in multiple local caches. Incoherent data can result from clients in a system maintaining caches of a common memory resource. Cache coherence mechanisms manage such conflicts by maintaining a coherent view of data values in multiple caches to identify scenarios where they may not match. Directory-based coherence is a particular mechanism for handling cache coherence issues. Directory-based coherence uses a special directory to serve coherence instead of using a shared bus. The special directory facilitates communication between multiple nodes to assure that coherence protocol is working correctly along all communicating nodes. In directory based cache coherence, the directory keeps track of the status for all cache blocks, where the status of a block includes a cache coherent state as well as an indication of which nodes share said block. Each of the multiple local caches serves the memory access requests of a processor local to the cache. A processor may issue a memory barrier instruction. If a processor issues memory access instructions and then issues a memory barrier instruction, then the effects of processor's memory access are ensured to have been propagated to all caches before the memory barrier instruction completes execution.

### SUMMARY

As disclosed herein, a computer implemented method for executing memory barrier instructions includes creating a transient table including entries, each entry corresponding to an address in a system, each entry including records corresponding to one or more participant caches in a system, receiving a command for the address from a participant cache, determining whether one or more outstanding requests exist from the other participant caches that must complete execution before a potential barrier command from the participant cache could complete execution, responsive to determining an outstanding request exists that must complete execution before the barrier command could completes execution, incrementing a counter to reflect an instance in which an address with one or more outstanding requests was accessed, detecting the complete execution of all of the one or more outstanding requests, responsive to detecting the complete execution of all of the one or more outstanding requests, decrementing the counter, determining whether the counter has a value of zero, and responsive to determining the counter has a value of zero, completing the execution of a memory barrier operation if such a barrier operation was outstanding. A computer program product and a computer system corresponding to the method are also disclosed.

### BRIEF DESCRIPTION OF THE DRAWINGS

FIG. 1 is a block diagram depicting an directory-based coherence system in accordance with at least one embodiment of the present invention;

FIG. 2 depicts a cache management method in accordance with at least one embodiment of the present invention;

FIG. 3 depicts an example of a directory table and a transient table and a memory barrier table in accordance with at least one embodiment of the present invention;

FIG. 4 depicts a command processing method in accordance with at least one embodiment of the present invention;

FIG. 5 depicts a command processing method in accordance with at least one embodiment of the present invention;

FIG. 6 depicts a command processing method in accordance with at least one embodiment of the present invention; and

FIG. 7 depicts a block diagram of components of a computer, in accordance with some embodiments of the present invention.

### DETAILED DESCRIPTION

The present invention will now be described in detail with reference to the Figures. Implementation of embodiments of the invention may take a variety of forms, and exemplary implementation details are discussed subsequently with reference to the Figures.

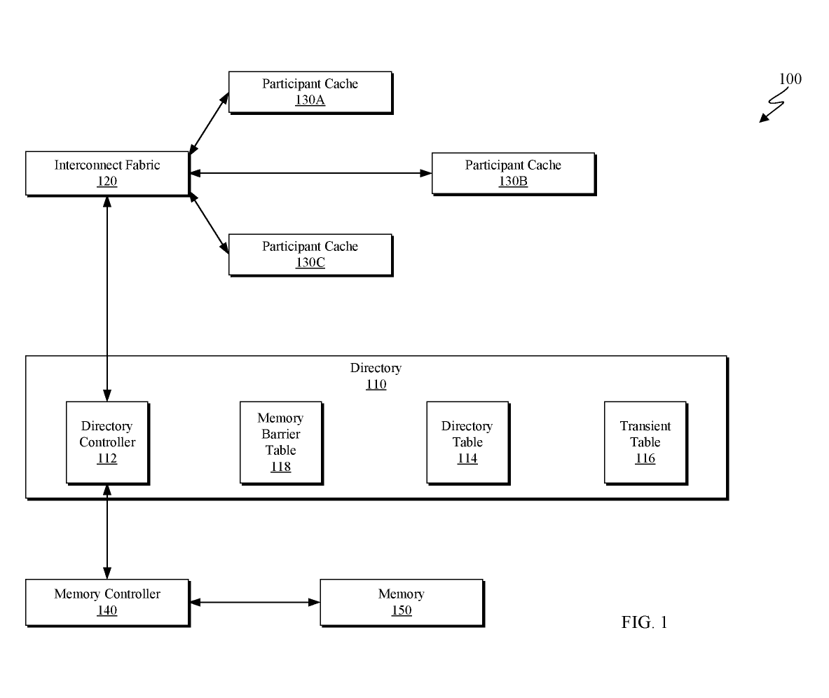

FIG. 1 is a block diagram depicting an directory-based coherence system 100 in accordance with at least one embodiment of the present invention. As depicted, directory-based coherence system 100 includes directory 110, interconnect fabric 120, participant caches 130, memory controller 140, and memory 150. Directory-based coherence system 100 enables cache coherence in systems implementing non-uniform memory access and in systems implementing uniform memory access.

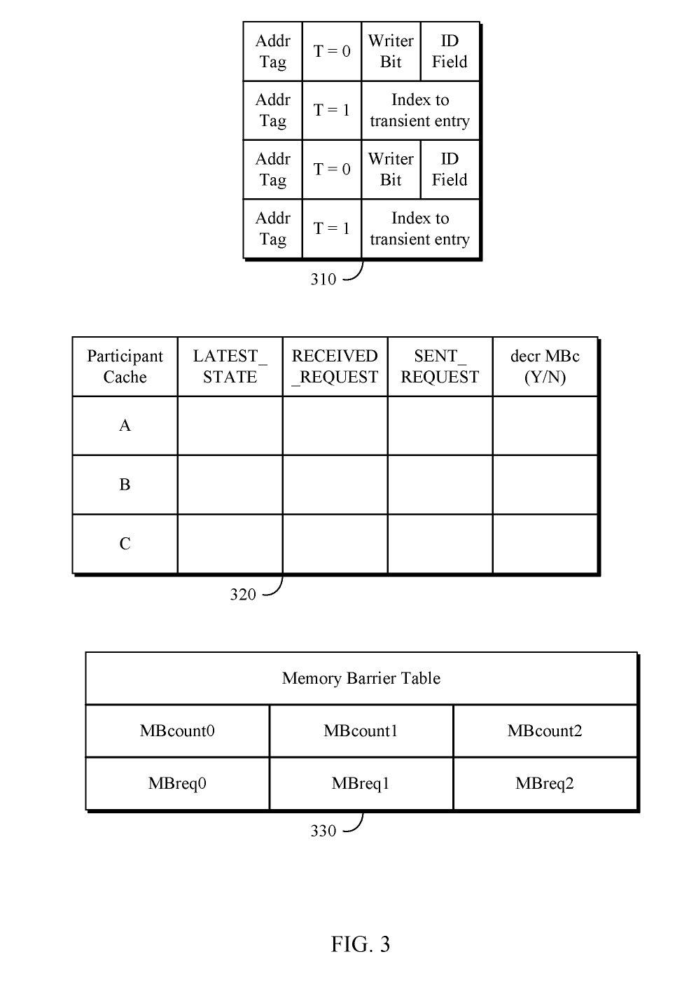

As depicted, directory 110 includes directory controller 112, directory table 114, transient table 116, and memory barrier table 118. Directory 110 maintains information of the state of each cache block in the system. A copy of a memory block in a participant cache is a cache block. A cache block is identified by an address. In at least some embodiments, directory controller 112 receives and sends requests to participant caches 130 via interconnect fabric 120. Directory controller 112 may additionally store an updated cache block to memory 150 via memory controller 140. In at least some embodiments, directory controller 112 utilizes directory table 114 and transient table 116 to maintain state information corresponding to the cache blocks in the participant caches. Example formats for the directory table 114 and the transient table 116 are depicted with respect to FIG. 3. In at least one embodiment, directory table 114 is a table containing information corresponding to one or more participant caches, as well as an indication of whether or not the address is currently in a stable state. For example, a transient bit in directory table 114 may be set to T=0 or T=1, wherein T=0 indicates that the corresponding cache is stable, and T=1 indicates that the corresponding cache is not stable. Transient table 116 may contain outstanding request information corresponding to the participant caches.

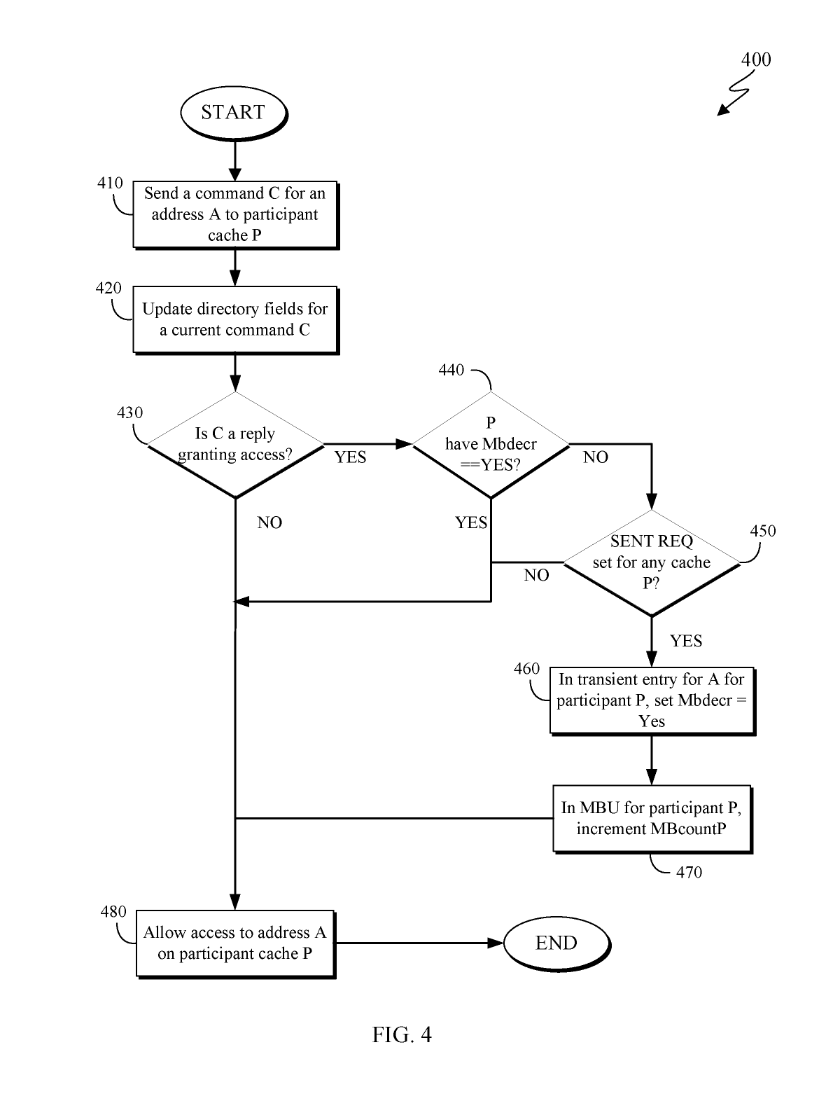

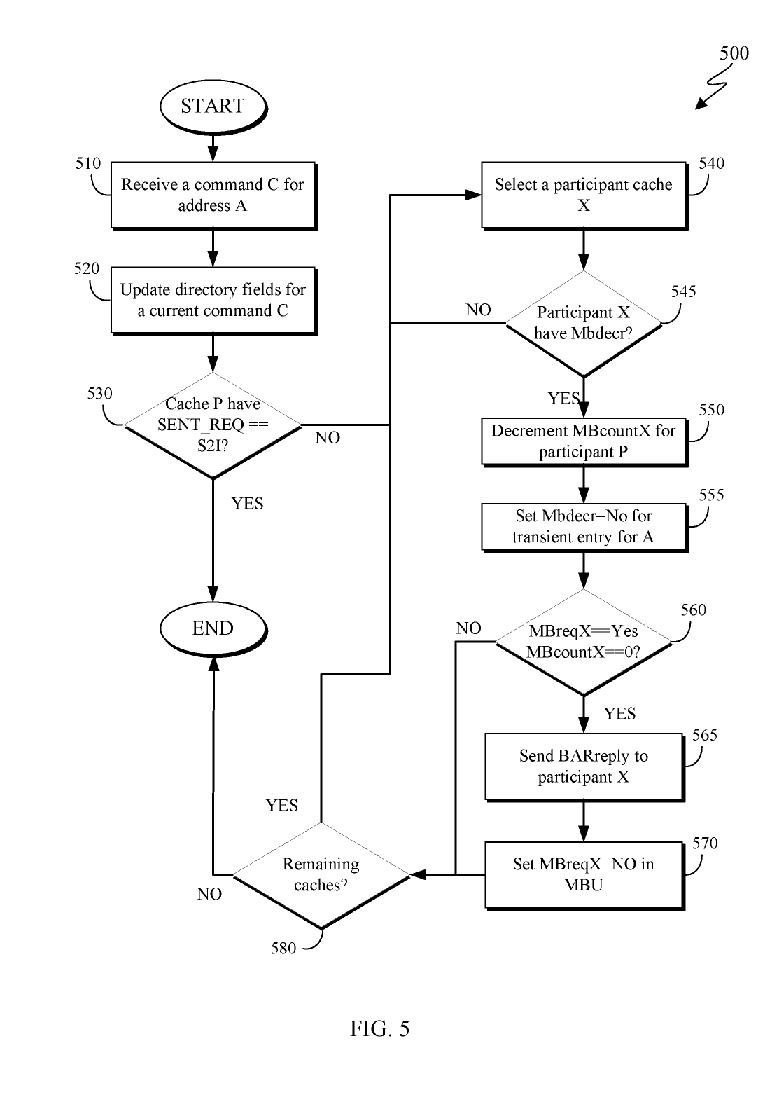

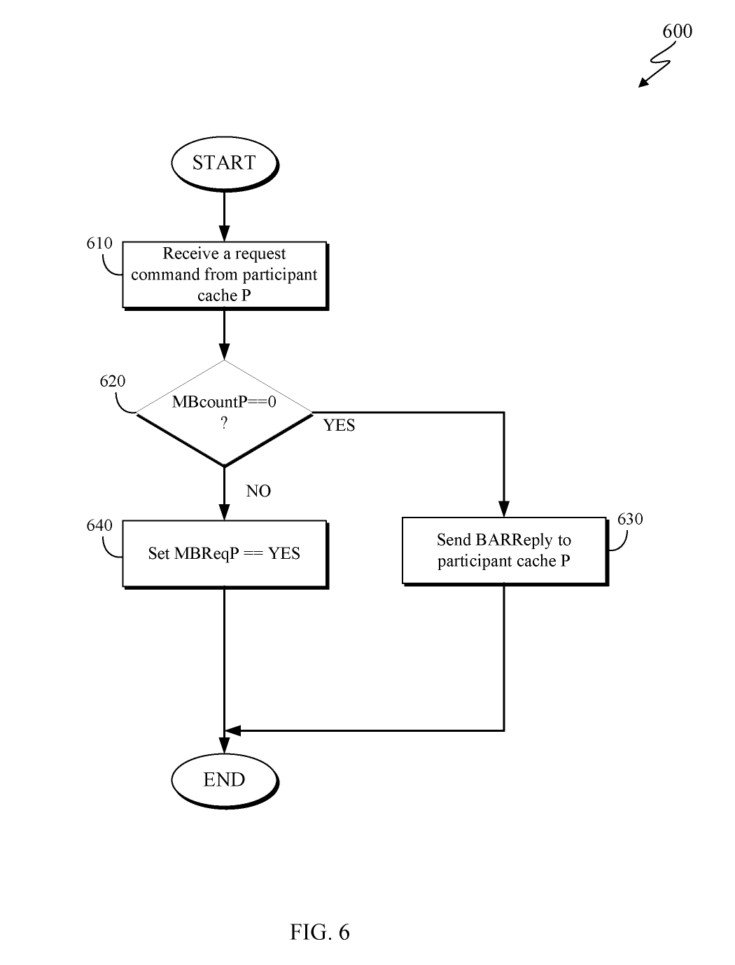

Directory controller 112 may be a module configured to execute a memory barrier (member, memory fence, fence instruction, etc.). A memory barrier is a type of barrier instruction that requires a central processing unit and compiler to enforce an ordering constraint on memory operations issued before and after the barrier instruction. This typically means that operations issued prior to the barrier are guaranteed to complete execution before operations issued after the barrier. Directory controller 112 may be configured to execute command processing methods, such as those discussed with respect to FIG. 4, FIG. 5, and FIG. 6.

Interconnect fabric 120 may be a computing fabric consisting of interconnected nodes that resemble a weave or a fabric when viewed collectively. In at least some embodiments, interconnect fabric 120 corresponds to a consolidated high-performance computing system consisting of loosely coupled storage, networking and parallel processing functions linked by high bandwidth interconnects. Interconnect fabric 120 can also correspond to a grid computing system in general. While interconnect fabric 120 is depicted separate from the participant caches 130 with respect to the depicted embodiment, it should be appreciated that in additional embodiments, the participant caches may be individual nodes within an interconnect fabric with which directory 110 communicates. In the depicted embodiment, the interconnect fabric 120 receives requests from and sends requests to each of participant nodes 130 and the directory 110.

Each of participant caches 130 corresponds to a hardware or software component that stores data so future requests for said data can be served faster. In an embodiment, each of participant caches 130 serves the memory access requests of a processor local to the participant cache. The data stored in each participant cache 130 can be the result of previous computations, the duplicate of data stored elsewhere, or any other data format known in the art. With respect to the depicted embodiment, participant caches 130 are configured to receive requests from and send requests to directory 110 via interconnect fabric 120. Each memory block of memory 150 may have a corresponding entry in the directory table 114 containing details specific to the zero or one cache block copy of the memory block in each corresponding participant cache 130. Each of participant caches 130 may be stored on a separate chip, or may be stored on a shared chip along with (or separate from) directory 110, memory controller 140 and memory 150.

Memory controller 140 may be a digital circuit configured to manage the flow of data going to and from memory 150. In some embodiments, memory controller 140 is a separate chip from the other components of directory-based coherence system 100. In other embodiments, memory controller 140 may be integrated into another element of directory-based coherence system 100. Memory 150 may be any volatile or non-volatile storage media known in the art. For example, memory 150 can be implemented with DRAM or Phase-Change Memory or NAND Flash. Similarly, data in memory 150 may conform to any suitable storage architecture known in the art, such as a file, a relational database, an object-oriented database, and/or one or more tables. With respect to the depicted embodiment, memory 150 may be configured to store information associated with directory table 114 and transient table 116 as provided by directory controller 112 via memory controller 140.

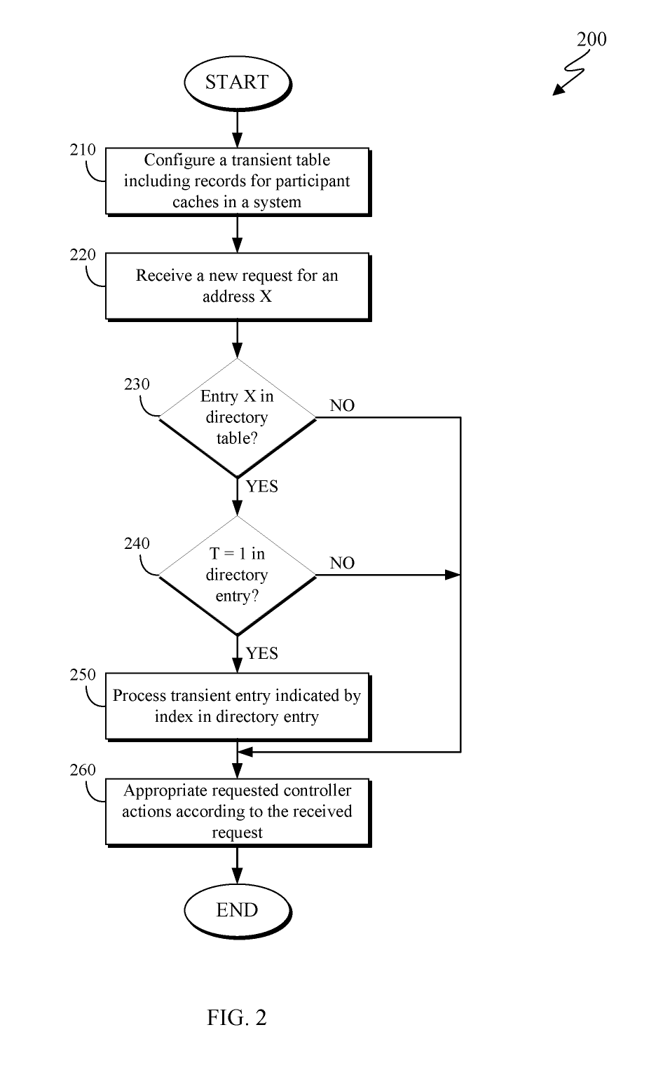

FIG. 2 depicts a cache coherence management method 200 in accordance with at least one embodiment of the present invention. As depicted, cache coherence management method 200 includes creating (210) a transient table including records for participant caches in a system, receiving (220) a new request for an address “X”, determining (230) whether an entry exists in the directory table for address “X”, determining (240) whether an entry exists in the transient table for address “X”, processing (250) the transient entry indicated by the index in the directory entry, and appropriating (260) requested controller actions according to the director entry, the transient entry, and the received request. Cache coherence management method 200 enables directory-based coherence with minimal resource requirements.

Creating (210) a transient table including records for participant caches in a system, may include creating a transient table containing a set of transient entries, with each transient entry corresponding to a single memory block with a unique address from within a system. In at least some embodiments, the created transient table includes, for each entry, a latest coherence state of the block at the participant cache known by the directory, any outstanding requests received by the directory from the participant caches, and any outstanding request sent by the directory to the participant caches. Creating (210) a transient table including records for participant caches may additionally include adding to each directory entry a bit, hereinafter referred to as ‘T’, which acts as an index to a valid transient entry for the corresponding memory block. An entry in the transient table may be created each time a cache enters a transient state. In some embodiments, creating each entry in the transient table begins by identifying an unused entry in the transient table and writing the data for a cache block entering a transient state in said unused entry. Certain situations may allow a smaller number of memory blocks to be in a transient state compared to the number of memory blocks in stable state; utilizing available empty transient entries in this manner as opposed to reserving a transient entry for each directory entry enables a smaller transient table to be used.

Receiving (220) a new request on an address “X” may include receiving a request from a participant cache for a specific address “X”. The received request may be a read request, a write request, or any other known request appropriate for execution with respect to address “X”. The node issuing the request on the address “X” may be referred to as a requestor node. The request is received by a directory node, which maintains the information of the state of each cache block in the system.

Determining (230) whether an entry exists in the directory table for address “X” may include parsing a directory table managed by the directory node to identify an entry corresponding to address “X” of a memory block. In an embodiment where each address is uniquely named, determining (230) whether an entry exists in the directory table for address “X” includes executing a search on the directory table to determine if a string in the address column of the directory table matches address “X”. In at least some embodiments, data is transferred between memory and cache in blocks of fixed size, referred to as cache lines or cache blocks. When a cache line is copied from memory into the cache, a cache entry is created. The cache entry will include the copied data as well as a requested memory location, sometimes called an address tag. If it is determined an entry exists in the directory table for address “X” (230, yes branch), the method continues by determining (240) whether an entry exists in the transient table for address “X”. If it is determined an entry does not exist in the directory for address “X” (230, no branch), the method continues by appropriating (260) the requested controller actions according to the received request.

Determining (240) whether an entry exists in the transient table for address “X” may include parsing the created transient table managed by the directory node to identify an entry corresponding to address “X”. In an embodiment where each address is uniquely named, determining (230) whether an entry exists in the directory table for address “X” includes executing a search on the directory table to determine if a string in the address column of the directory table matches address “X”. Other available address details may be used to identify the proper entry in the transient table in embodiments where each of the addresses are not uniquely named. In one embodiment, determining (240) whether an entry exists in the transient table for address “X” includes determining whether a T bit of the corresponding directory table entry is set to 1. If it is determined that an entry exists in the transient table for address “X” (240, yes branch), the method continues by processing the transient entry indicated by the index in the directory entry. If it is determined that an entry does not exist in the transient table for address “X” (240, no branch), the method continues by appropriating (260) the requested controller actions according to the received request.

Processing (250) the transient entry indicated by the index in the directory entry may include determining the current state of the address “X” according to the transient entry. In some embodiments, each entry in the transient table corresponds to an address X and indicates for each participant cache a latest state, any outstanding request received by the directory, and any outstanding request sent by the directory. In such embodiments, processing (250) the transient entry indicated by the index includes updating the transient entry indicated by the index in the directory entry to reflect the received request. Processing (250) the transient entry indicated by the index in the directory entry includes identifying a current state of address “X” along with any outstanding requests prior to executing the received request on address “X”.

Appropriating (260) requested controller actions according to the director entry, the transient entry, and the received request may include executing the received request on address “X”. Executing the received request on address “X” may require the transient table entry corresponding to address “X” to be updated. For example, if the request on address “X” places address “X” into a transient state, an entry in the transient table may need to be created or updated to reflect the outstanding request. If the received request places address “X” in a stable state, the transient table may need to be updated such that the latest state entry reads “Stable”. In some embodiments, where the received request places address “X” in a stable state, the transient table entry corresponding to address “X” is transferred to the directory entry and the transient entry is cleared to make room for an entry corresponding to another address. As used herein, an entry in a stable state indicates that the directory has no outstanding request to or from the corresponding participant cache.

FIG. 3 depicts an example of a directory table 310 with 4 directory entries and a transient table entry 320 and a memory barrier table 330 in accordance with one embodiment of the present invention. As depicted, each row of directory table 310 is a directory entry and corresponds to a unique address, indicated by the address tag (labeled Addr Tag) in each entry in the first column. In an embodiment, an invalid directory entry is indicated by an invalid value for its Addr Tag. Each entry in the second column of each row, in other words of each directory entry, corresponds to a transient bit that indicates whether or not there exists an entry in the transient table 116 corresponding to the address indicated by the Addr Tag in the directory entry. In some embodiments, a non-zero entry in the transient bit column indicates that the corresponding address is not in a stable state, also known as a transient state. For a row which has a zero entry in the transient bit column, the following two columns contain an indication of the writer bit and the ID field corresponding to the address indicated by said row. If the writer bit is set, the ID field identifies the participant cache with write access to the cache block. If the writer bit is not set, the ID field identifies the one or more participant caches, each with a non-writable shared-read access to the cache block. For a row which does have a corresponding transient table entry, the remaining column includes an index to the corresponding entry in the transient table. Thus the transient entry is located without searching a table of transient entries, thus reducing computer resources.

Transient table entry 320 is one example of a transient table entry adequate for tracking participant cache status for a memory line. As depicted, transient table entry 320 includes four columns. The first column indicates a participant cache. In an embodiment, the first column may not be explicit and instead a first participant cache is identified by the first row, a second participant cache is identified by the second row and so on. The second column indicates the latest stable state known by the directory for the address at the participant cache. In an embodiment, the second column contains a label indicating 1 of the 4 states (ModifiedWrite, ExclusiveWrite, SharedRead. Invalid) of the MESI protocol for the address at the participant cache. As used herein, a cache is considered to be in a stable state if it has no outstanding received or outgoing requests. The third column of transient table entry 320 indicates any outstanding request received by the directory from the participant cache. Similarly, the fourth column of transient table entry 320 indicates any outstanding request sent by the directory to the participant cache. The fifth column of transient table entry 320 indicates whether a counter corresponding to the participant cache in the Memory Barrier Table was incremented in response to the participant cache accessing the line before one or more other participant caches completed their access to the line. When all the other participant caches subsequently complete their access to the line, then if the fifth column of transient table entry 320 was set, then the fifth column is cleared and the counter corresponding to the participant cache in the Memory Barrier Table is decremented.

Memory Barrier Table 330 is one example of a Memory Barrier Table adequate for implementing a barrier instruction. As depicted, Memory Barrier Table 330 includes three columns. Each column corresponds to a participant cache. In an embodiment, the first column corresponds to a first participant cache, a second column corresponds to a second participant cache and so on. Within a column, the first entry records the number of lines with distinct addresses accessed by the participant cache, where for each distinct line a prior access by another participant cache has not yet completed. Within a column, the second entry records whether a barrier instruction request has been received from the participant cache, but the barrier instruction execution could not yet complete since the first entry in the column recorded a number of one or more lines. Within a column, when the first entry records a number zero, then if the second entry was set, then the second entry is cleared and a barrier instruction reply is sent to the participant corresponding to this column of the memory barrier table 330.

FIG. 4 depicts a command processing method 400 in accordance with at least one embodiment of the present invention. In an embodiment, command processing method 400 is part of the method appropriating (260) the requested controller actions according to the received request. As depicted, command processing method 400 includes sending (410) a command C for an address A to a participant cache P, updating (420) directory fields for the current command C, determining (430) whether the command C is a reply granting a cache line to participant cache P, determining (440) whether the counter in the Memory Barrier Table corresponding to the participant cache has been previously incremented for a access to address A, determining (450) whether one or more requests previously sent by the directory to another participant cache has not yet completed, setting (460) an indicator MBdecr to the yes position for a transient entry for address A, and incrementing (470) a counter MBcountP. In at least one embodiment, command processing method 400 is implemented to process non-barrier commands sent by a directory.

Sending (410) a command C for an address A to a participant cache P may include identifying an outstanding action to be executed that requires a command be created and sent. In at least some embodiments, sending (410) a command C includes receiving a request requesting a function be executed on address A of participant cache P.

Updating (420) directory fields for the current command C may include identifying an entry in a directory table corresponding to the sent command C. In at least some embodiments, updating (420) directory fields for command C includes updating the entry to indicate where the command was sent from, where its intended destination is, what type of command it is, as well as any other execution details corresponding to the command C. Updating (420) directory fields for the current command C may additionally include updating a transient entry in the directory field to reflect that there exists an outstanding request (in this case, command C) on the participant cache.

Determining (430) whether the command C is a reply granting a cache line to participant cache P may include determining whether command C is requesting access to one or more external resources. In at least some embodiments, determining (430) whether the command C is a reply granting a cache line to participant cache P includes determining whether command C is intended to edit or otherwise alter an external resource. If it is determined that the command C is a reply granting a cache line to participant cache P (430, yes branch), the method continues by determining (440) whether the counter in the Memory Barrier Table corresponding to the participant cache has been previously incremented for a access to address A. If it is determined that the command does not correspond to a reply granting a cache line to participant cache P (430, no branch), the method concludes.

Determining (440) whether the counter in the Memory Barrier Table corresponding to the participant cache has been previously incremented may include analyzing a transient table entry. In at least some embodiments, a transient table containing an entry corresponding to participant cache P includes a column indicating whether or not the counter in the Memory Barrier Table corresponding to the participant cache has been previously incremented. Such an entry may include a simple YES/NO indicator or switch. A counter in the Memory Barrier Table corresponding to the participant cache may be decremented when its corresponding command C is fully propagated. If the counter in the Memory Barrier Table corresponding to the cache P has been previously incremented (440, yes branch), the method concludes. If the counter in the Memory Barrier Table corresponding to the participant cache P has not been previously incremented (440, no branch), the method continues by determining (450) whether one or more requests previously sent by the directory to another participant cache has not yet completed.

Determining (450) whether one or more requests previously sent by the directory to another participant cache has not yet completed may include analyzing a transient table entry corresponding to the memory block with address A. In at least some embodiments, a transient table entry includes columns indicating outstanding sent and received requests corresponding to each participant caches in the table. Determining (450) whether one or more requests previously sent by the directory to another participant cache has not yet completed may include analyzing the appropriate columns in address A's transient table entry to determine if a request is outstanding. If no outstanding request has been sent by the directory (450, no branch), the method concludes. If an outstanding request has been sent by the directory (450, yes branch), the method continues by setting (460) the decremental indicator to the yes position.

Setting (460) an indicator MBdecr to the yes position for a transient entry for address A may including editing participant cache P's column in the transient table entry to indicate that the counter in the Memory Barrier Table corresponding to the participant cache P is incremented. In some embodiments, the counter in the Memory Barrier Table corresponding to the participant cache P is decremented when the corresponding command C has been fully propagated. Once the decremental indicator has been adjusted, the method continues by incrementing (470) a counter MBcountP in a memory barrier table. The memory barrier table may contain one or more counters corresponding to one or more participant caches.

FIG. 5 depicts a command processing method 500 in accordance with at least one embodiment of the present invention. In an embodiment, command processing method 500 is part of the method appropriating (260) the requested controller actions according to the received request. As depicted, command processing method 500 includes receiving (510) a command C for an address A, updating (520) directory fields for the received command C, determining (530) whether any cache P indicates an outstanding request has been sent by the directory, selecting (540) a participant cache, determining (545) whether the counter in the Memory Barrier Table corresponding to the selected participant cache has been incremented, decrementing (550) a counter in the Memory Barrier Table for the selected cache, setting (555) an indicator MBdecr to NO for address A, determining (560) for the Memory Barrier Table whether an outstanding barrier request for cache X exists and whether the counter for cache X is at 0, sending (565) a BARreply to participant cache X, setting (570) an indicator to a position to indicate no outstanding barrier requests exist in the memory barrier table for participant cache X, and determining (580) if any more caches meeting the criteria exist. Command processing method 500 may be implemented to process non-barrier commands received by a directory.

Receiving (510) a command C for an address A may include identifying an outstanding action to be execute. In at least some embodiments, receiving (510) a command C includes receiving a request indicating a function be executed on an address A. In at least some embodiments, the received command C may not explicitly indicate a participant cache on which to execute the command C at address A.

Updating (520) directory fields for the received command C may include identifying an entry in a directory table corresponding to the sent command C. In at least some embodiments, updating (520) directory fields for command C includes updating the entry to indicate where the command was sent from, where its intended destination is, what type of command it is, as well as any other execution details corresponding to the command C.

Determining (530) whether any cache X indicates an outstanding request has been sent by the directory may include analyzing a transient table entry corresponding to the address A indicated by the command. In at least some embodiments, a transient table entry includes columns indicating outstanding sent and received requests corresponding to the participant caches in the system. Determining (530) whether an entry indicates an outstanding request has been sent by the directory may include analyzing the transient table entry corresponding to address A to determine if a request is outstanding with respect to a participant cache X. If no such cache exists (530, no branch), the method continues by selecting (540) a participant cache. If cache P indicates a request has been sent by the directory (530, yes branch), the method concludes. Selecting (540) a participant cache may include simply selecting the first cache, then the second, and so on.

Determining (545) whether the counter in the Memory Barrier Table corresponding to selected participant cache X has been incremented may include analyzing a transient table entry. In at least some embodiments, a transient table containing an entry corresponding to a memory block at a given address includes a column indicating whether or not the counter in the Memory Barrier Table corresponding to the participant cache is incremented. Such an entry may include a simple YES/NO indicator or switch. A counter in the Memory Barrier Table corresponding to a participant cache may be decremented when its corresponding command C is fully propagated. If the counter in the Memory Barrier Table corresponding to a participant cache X has not been incremented (545, no branch), the method continues by determining (580) whether any caches remain. If cache P has been decremented (545, yes branch), the method continues by decrementing (550) a counter in the Memory Barrier Table corresponding to the selected cache X.

Decrementing (550) a counter for the selected cache may include decreasing the counter for cache X by 1. In at least some embodiments, the counter for cache X is stored in a memory barrier table.

Setting (555) an indicator MBdecr to NO for address A may include altering a transient table entry corresponding to address A on participant cache X. In at least some embodiments, setting (555) an indicator MBdecr to no for address A includes identifying an MBdecr column corresponding to address A on participant cache X, and recording an entry of NO in said column. The recorded no entry indicates that the counter in the Memory Barrier Table corresponding to for the selected cache X is not currently incremented for the corresponding address.

Determining (560) for the Memory Barrier Table whether an outstanding barrier request for cache X exists and whether the counter for cache X is at 0 may include analyzing a MBreq entry corresponding to cache X. If the MBreq entry indicates yes, then an outstanding request from the corresponding cache X exists. Determining (560) whether the counter for cache X is at 0 may include analyzing a counter corresponding to cache X to identify the value indicated by the counter. If both of the above conditions are found to be true, the method continues by sending (565) a BARreply to the participant cache X. If either or both of the above conditions are found to be false, the method continues by determining (580) whether any caches remain.

Sending (565) a BARreply to participant cache X may include sending a memory barrier reply to the participant cache X in response to the command C received by the directory. In at least some embodiments, the BARreply is a standard reply indicating that the command was received and processed by the directory controller 112. In some embodiments, the BARreply may indicate either that the command C has been allowed to be executed as intended with respect to the address A, or that the command C has been denied. The BARreply can additionally include an indication of one or more defects or non-conforming properties that prevent the command from being executed as intended. In other embodiments, the BARReply is simply a memory barrier instruction configured to enforce the order of the surrounding operations.

Setting (570) an indicator to a position to indicate no outstanding requests exist in the memory barrier table for participant cache X may include updating an entry in a memory barrier table to reflect that there are no outstanding request corresponding to participant cache X. In at least one embodiment, a memory barrier table contains an entry titled MBreqX that can be either a “YES” entry or a “NO” entry. In this case, a “YES” entry would indicate there are outstanding requests in the system with respect to participant cache X, while a “NO” entry would indicate there are no such outstanding requests. In at least some embodiments, MBreq corresponds to a number of commands waiting to complete execution after the system issues a memory barrier instruction. In a preferred embodiment, MBreq corresponds to a single outstanding barrier command.

Determining (580) if any more caches meeting the criteria exist may include analyzing a transient table again with respect to the address A to determine if any additional unchecked caches meet the criteria. If additional caches do indeed exist (580, yes branch), the method continues by returning to selecting (540) a participant cache. If no additional caches meeting the criteria exist (580, no branch), the method terminates.

FIG. 6 depicts a command processing method 600 in accordance with at least one embodiment of the present invention. As depicted, command processing method 600 includes receiving (610) a barrier request command from a participant cache P, determining (620) if a memory barrier counter corresponding to participant cache P is set to 0, sending (630) a BARReply to participant cache P, and setting (640) an indicator to a position to indicate there is an outstanding barrier request in the system with respect to participant cache P. Command processing method 600 may be appropriate for barrier commands received by a directory.

Receiving (610) a barrier request command from a participant cache P may include identifying an outstanding action to complete execution with respect to participant cache P. In at least some embodiments, receiving (610) a command C includes receiving a request indicating a function be executed on an address. In at least some embodiments, the received request command C may be of a format specific to requests made with respect to a memory barrier.

Determining (620) if a memory barrier counter corresponding to participant cache P is set to 0 may include identifying a memory barrier counter corresponding to the indicated participant cache P. A memory barrier table may contain one or more counters, with each counter corresponding to a participant cache. If it is determined that the memory barrier counter is set to 0 (620, yes branch), the method continues by sending (630) a BARReply to participant cache P. If it is determined that the memory barrier counter is not set to 0 (620, no branch), the method continues by setting (640) an indicator to a position to indicate there is an outstanding barrier request in the system with respect to participant cache P.

Sending (630) a BARReply to participant cache P may include sending a memory barrier reply to the participant cache P in response to the command C received by the directory. In at least some embodiments, the BARreply is a standard reply indicating that the command was received and processed by the directory controller 112. In some embodiments, the BARreply may indicate either that the command C has been allowed to be executed as intended with respect to the participant cache P, or that the command C has been denied. The BARreply can additionally include an indication of one or more defects or non-conforming properties that prevent the command from being executed as intended.

Setting (640) an indicator to a position to indicate there is an outstanding request in the system with respect to participant cache P may include updating an entry in a memory barrier table to reflect that there is an outstanding request corresponding to participant cache P. In at least one embodiment, a memory barrier table contains an entry titled MBreqP that can be either a “YES” entry or a “NO” entry. In this case, a “YES” entry would indicate there are outstanding requests in the system with respect to participant cache P, while a “NO” entry would indicate there are no such outstanding requests. In this embodiment, setting (640) an indicator to a position to indicate there is an outstanding request in the system would include recording an entry of “YES” in the corresponding table entry. In other embodiments, the BARReply is simply a memory barrier instruction configured to enforce the order of the surrounding operations.

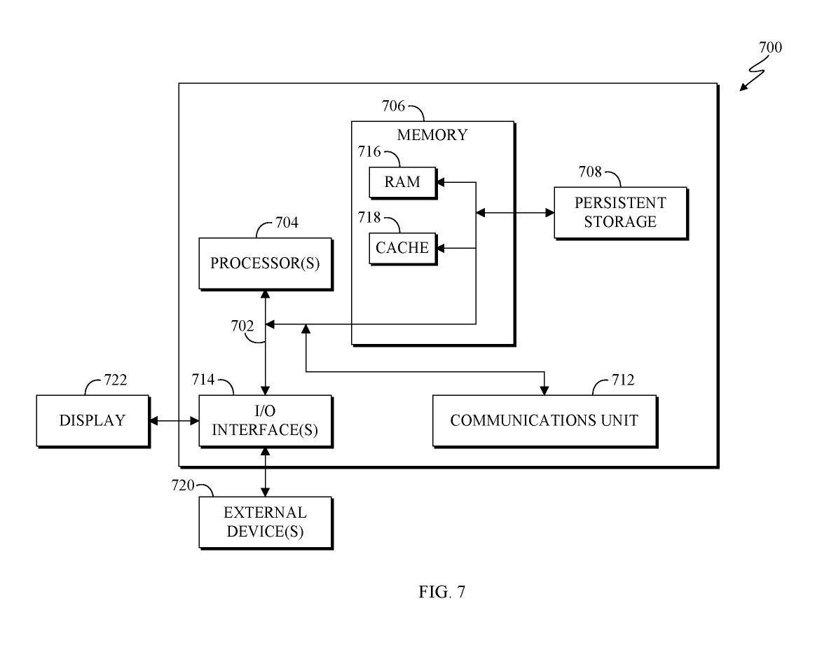

FIG. 7 depicts a block diagram of components of computer 700 in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

As depicted, the computer 700 includes communications fabric 702, which provides communications between computer processor(s) 704, memory 706, persistent storage 708, communications unit 712, and input/output (I/O) interface(s) 714. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 716 and cache memory 718. In general, memory 706 can include any suitable volatile or non-volatile computer-readable storage media.

One or more programs may be stored in persistent storage 708 for access and/or execution by one or more of the respective computer processors 707 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links.

I/O interface(s) 714 allows for input and output of data with other devices that may be connected to computer 700. For example, I/O interface 714 may provide a connection to external devices 720 such as a keyboard, keypad, a touch screen, and/or some other suitable input device. External devices 720 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 708 via I/O interface(s) 714. I/O interface(s) 714 also connect to a display 722.

Display 722 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method comprising:
creating a transient table including one or more entries wherein each entry corresponds to one or more participant caches in the system, and wherein the transient table entry includes for a corresponding participant cache a column indicating whether or not a corresponding counter in a memory barrier table has been incremented;
receiving a command for an address from the corresponding participant cache;
determining whether one or more outstanding requests exist from other participant caches that must complete execution before a barrier command from the corresponding participant cache could complete executed with respect to the participant cache;
responsive to determining an outstanding request exists that must complete execution before a barrier command completes execution, incrementing the counter to reflect an instance in which an address with one or more outstanding requests was accessed;
detecting the execution of the one or more outstanding requests;
responsive to detecting the execution of the one or more outstanding requests, decrementing the counter;
determining whether the counter has a value of zero; and
responsive to determining the counter has a value of zero, completing the execution of the memory barrier operation.

2. The computer implemented method of claim 1, wherein the transient table entry includes for a corresponding participant cache a column indicating whether or not a corresponding counter in a memory barrier table has been incremented once in response to one or more outstanding commands that must complete execution before a potential memory barrier instruction issued by the corresponding participant cache could complete execution.

3. The computer implemented method of claim 1, further comprising updating one or more directory fields in a directory table entry corresponding to the address of the received command.

4. The computer implemented method of claim 2, wherein each entry of the created transient table indicates for each participant cache whether there are any unresolved requests either sent by or received by the corresponding participant cache.

5. The computer implemented method of claim 1, further comprising creating a memory barrier table comprising one or more entries corresponding to the one or more participant caches in the system.

6. The computer implemented method of claim 5, wherein at least one entry for a corresponding cache in the memory barrier table indicates a counter corresponding to how many commands from the corresponding participant cache each require one or more command from other caches to complete execution, such that a memory barrier instruction issued by the corresponding cache could complete execution.

7. The computer implemented method of claim 6, wherein at least one entry for a corresponding cache in the memory barrier table is set when the corresponding cache issues a memory barrier instruction and is cleared when the counter reaches 0 and the memory barrier instruction can complete execution.

8. A computer program product comprising:
one or more computer readable storage media and program instructions stored on the one or more computer readable storage media, the program instructions comprising instructions to:
create a transient table including records corresponding to one or more participant caches in a system, wherein the transient table includes a column indicating whether or not a memory barrier table has counted outstanding commands that must execute before a memory barrier instruction issues to a corresponding participant cache;
receive a command for an address corresponding to one of the one or more participant caches;
determine whether one or more outstanding requests exist that must be executed before a barrier command is executed with respect to the participant cache;
responsive to determining an outstanding request exists that must be executed before a barrier command is executed, increment a counter to reflect an instance in which an address with one or more outstanding requests was accessed;
detect the execution of the one or more outstanding requests;
responsive to detecting the execution of the one or more outstanding requests, decrement the counter;
determine whether the counter has a value of zero; and
responsive to determining the counter has a value of zero, issue a memory barrier operation.

9. The computer program product of claim 8 wherein each entry of the created transient table corresponds to one of the one or more participant caches in the system.

10. The computer program product of claim 8, further comprising instructions to update one or more directory fields in a directory table entry corresponding to the received command.

11. The computer program product of claim 9, wherein each entry of the created transient table indicates whether there are any unresolved requests either sent by or received by the corresponding participant cache.

12. The computer program product of claim 8, further comprising instructions to create a memory barrier table comprising one or more entries corresponding to the one or more participant caches in the system.

13. The computer program product of claim 12, wherein at least one entry in the memory barrier table indicates a counter corresponding to how many commands have been executed on a corresponding participant cache since a last memory barrier instruction was issued.

14. The computer program product of claim 12, wherein at least one entry in the memory barrier table indicates a number of outstanding requests that must execute before a memory barrier instruction is issued.

15. A computer system comprising:
one or more computer processors;
one or more computer readable storage media;
program instructions stored on the one or more computer readable storage media, the program instructions comprising instructions to:
create a transient table including records corresponding to one or more participant caches in a system, wherein the transient table includes a column indicating whether or not a memory barrier table has counted outstanding commands that must execute before a memory barrier instruction issues to a corresponding participant cache;
receive a command for an address corresponding to one of the one or more participant caches;
determine whether one or more outstanding requests exist that must be executed before a barrier command is executed with respect to the participant cache;
responsive to determining an outstanding request exists that must be executed before a barrier command is executed, increment a counter to reflect an instance in which an address with one or more outstanding requests was accessed;
detect the execution of the one or more outstanding requests;
responsive to detecting the execution of the one or more outstanding requests, decrement the counter;
determine whether the counter has a value of zero; and
responsive to determining the counter has a value of zero, issue a memory barrier operation.

16. The computer system of claim 15 wherein each entry of the created transient table corresponds to one of the one or more participant caches in the system.

17. The computer system of claim 15, further comprising instructions to update one or more directory fields in a directory table entry corresponding to the received command.

18. The computer system of claim 16, wherein each entry of the created transient table indicates whether there are any unresolved requests either sent by or received by the corresponding participant cache.

19. The computer system of claim 15, further comprising instructions to create a memory barrier table comprising one or more entries corresponding to the one or more participant caches in the system.

20. The computer system of claim 19, wherein at least one entry in the memory barrier table indicates a counter corresponding to how many commands have been executed on a corresponding participant cache since a last memory barrier instruction was issued.
